(19) United States
(12) Patent Application Publication
(10) Pub. No.: US 2026/0280186 A1
(43) Pub. Date: Sep. 17, 2026

(54) ENGAGEMENT MECHANISM AND CONNECTOR UNIT

(71) Applicant: YAZAKI CORPORATION, Tokyo (JP)

(72) Inventors: Masanori Nakamura, Kakegawa-shi (JP); Takao Murakami, Hamamatsu-shi (JP); Yutarou Minami, Kakegawa-shi (JP)

(21) Appl. No.: 19/557,117

(22) Filed: Mar. 5, 2026

(30) Foreign Application Priority Data
Mar. 17, 2025 (JP) 2025-042580

(51) Int. Cl. H01R 13/629; B60L 53/16

(52) U.S. Cl. CPC H01R 13/629; B60L 53/16; H01R 2201/26

(57) ABSTRACT

An engagement mechanism is capable of switching between engagement and disengagement with an engagement target. The engagement mechanism includes an engagement portion disposed at an engagement position where the engagement portion is engaged with the engagement target and a disengagement position where the engagement portion is not engaged with the engagement target; a drive portion operating to dispose the engagement portion at the engagement position or the disengagement position; an elastic portion provided between the drive portion and the engagement portion, transmitting the operation of the drive portion to the engagement portion, and elastically deformable; and an operation portion that executes a release operation of moving the engagement portion at the engagement position toward the disengagement position while elastically deforming the elastic portion, independently of the operation of the drive portion.

### CROSS-REFERENCE TO RELATED APPLICATIONS

This application is based on and claims priority under 35 USC 119 from Japanese Patent Application No. 2025-042580 filed on Mar. 17, 2025, the contents of which are incorporated herein by reference.

### TECHNICAL FIELD

The present disclosure relates to an engagement mechanism capable of switching between engagement and disengagement with an engagement target, and a connector unit using the engagement mechanism.

### BACKGROUND ART

In the related art, a charging connector unit for supplying electric power from the outside of a vehicle to a battery mounted on the vehicle or the like has been proposed. This type of connector unit generally includes a charging inlet that is a connector mounted on a vehicle or the like, and a charging gun that is a connector connected to a power supply outside the vehicle (see, for example, Patent Literature 1).

### CITATION LIST

### Patent Literature

Patent Literature 1: JP2020-129465A

### SUMMARY OF INVENTION

In the connector unit in the related art described above, a lock pin provided on the charging inlet is engaged with the charging gun for the purpose of maintaining a state in which the connectors are fitted to each other. The lock pin is driven by a motor, a gear, or the like that operates in response to an instruction signal from the outside, and is displaced between a position where the lock pin is engaged with the charging gun and a position where the lock pin is not engaged with the charging gun. However, when a malfunction occurs in the operation of the motor, the gear, or the like due to aging deterioration or the like, it may become impossible to move the lock pin from the position where the lock pin is engaged with the charging gun to the position where the lock pin is not engaged with the charging gun (that is, to release the lock), making it difficult to separate the charging gun from the charging inlet. For this reason, it is desired to provide the connector unit with a mechanism for appropriately releasing the lock. As understood from the present description, it is desirable to provide the mechanism not only in the connector unit described above but also in various engagement mechanisms.

An object of the present disclosure is to provide an engagement mechanism capable of appropriately switching between engagement and disengagement with an engagement target, and a connector unit using the engagement mechanism.

In order to achieve the above object, an engagement mechanism and a connector unit according to the present disclosure has the following features.

The engagement mechanism of the present disclosure is capable of switching between engagement and disengagement with an engagement target. The engagement mechanism includes an engagement portion that is disposed at an engagement position where the engagement portion is engaged with the engagement target and a disengagement position where the engagement portion is not engaged with the engagement target; a drive portion that operates to dispose the engagement portion at the engagement position or the disengagement position; an elastic portion that is provided between the drive portion and the engagement portion, transmits the operation of the drive portion to the engagement portion, and is elastically deformable; and an operation portion that executes a release operation of moving the engagement portion at the engagement position toward the disengagement position while elastically deforming the elastic portion, independently of the operation of the drive portion.

The connector unit according to the present disclosure includes a first connector including the above engagement mechanism and a second connector as the engagement target.

According to the engagement mechanism of the present disclosure, the operation of the drive portion (for example, a gear structure such as a rack and a pinion, and a power source such as a motor) is transmitted to the engagement portion (for example, a lock pin) via the elastic portion (for example, a coil spring), so that the engagement portion is disposed at the engagement position or the disengagement position. Even if a malfunction occurs in the operation of the drive portion, the engagement between the engagement target and the engagement portion can be released by performing the release operation of moving the engagement portion at the engagement position toward the disengagement position while elastically deforming the elastic portion using the operation portion (for example, an emergency lever) independent of the operation of the drive portion. Therefore, the engagement mechanism of the present disclosure can appropriately switch between engagement and disengagement with the engagement target.

Further, according to the connector unit of the present disclosure, the operation of the drive portion provided in the first connector (for example, the charging inlet) is transmitted to the engagement portion via the elastic portion, so that the engagement portion is disposed at the engagement position or the disengagement position. Even if a malfunction occurs in the operation of the drive portion, the engagement between the second connector (for example, the charging gun), which is the engagement target, and the engagement portion can be released by performing the release operation of moving the engagement portion at the engagement position toward the disengagement position while elastically deforming the elastic portion using the operation portion (for example, an emergency lever) independent of the operation of the drive portion. Therefore, the connector unit of the present disclosure can appropriately switch between engagement and disengagement between the engagement portion of the first connector and the second connector.

The present disclosure has been briefly described above. Further, details of the present disclosure will be further clarified by reading modes for carrying out the invention described below with reference to the accompanying drawings.

### BRIEF DESCRIPTION OF DRAWINGS

FIG. 1 is a schematic configuration diagram illustrating a connector unit including an engagement mechanism according to an embodiment of the present disclosure;

FIG. 2 is a diagram corresponding to FIG. 1 for illustrating a first procedure for separating the second connector from the first connector when an actuator portion is normal;

FIG. 3 is a diagram corresponding to FIG. 1 for illustrating a second procedure for separating the second connector from the first connector when the actuator portion is normal;

FIG. 4 is a diagram corresponding to FIG. 1 for illustrating a first procedure for separating the second connector from the first connector when there is an abnormality in the actuator portion; and

FIG. 5 is a diagram corresponding to FIG. 1 for illustrating a second procedure for separating the second connector from the first connector when there is the abnormality in the actuator portion.

### DESCRIPTION OF EMBODIMENTS

### Embodiment

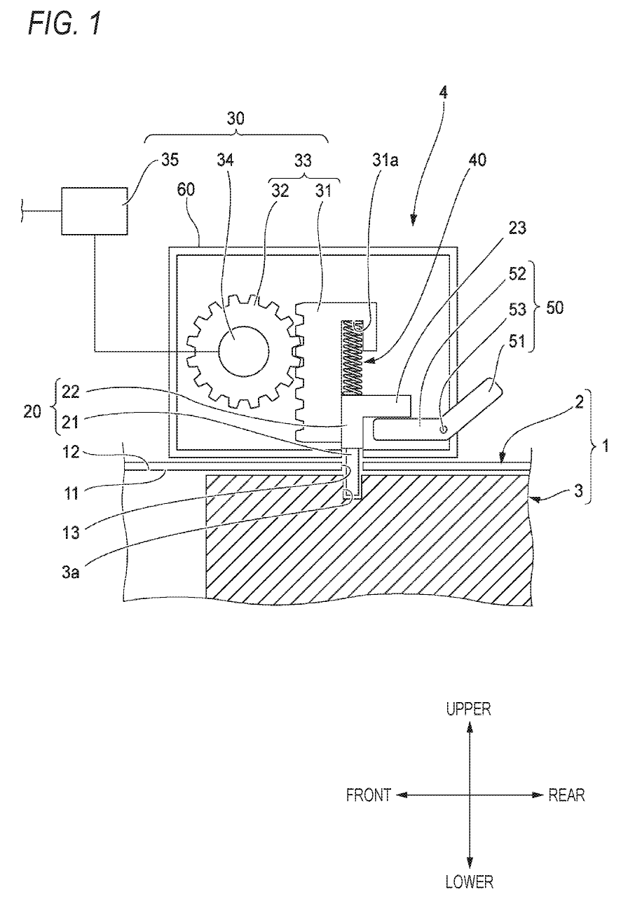

Hereinafter, a connector unit 1 according to an embodiment of the present disclosure including an actuator portion 4 according to an embodiment of the present disclosure will be described with reference to the drawings. As illustrated in FIG. 1, the connector unit 1 includes a connector 2 including the actuator portion 4 and a connector 3 fitted into a fitting recess 11 of the connector 2.

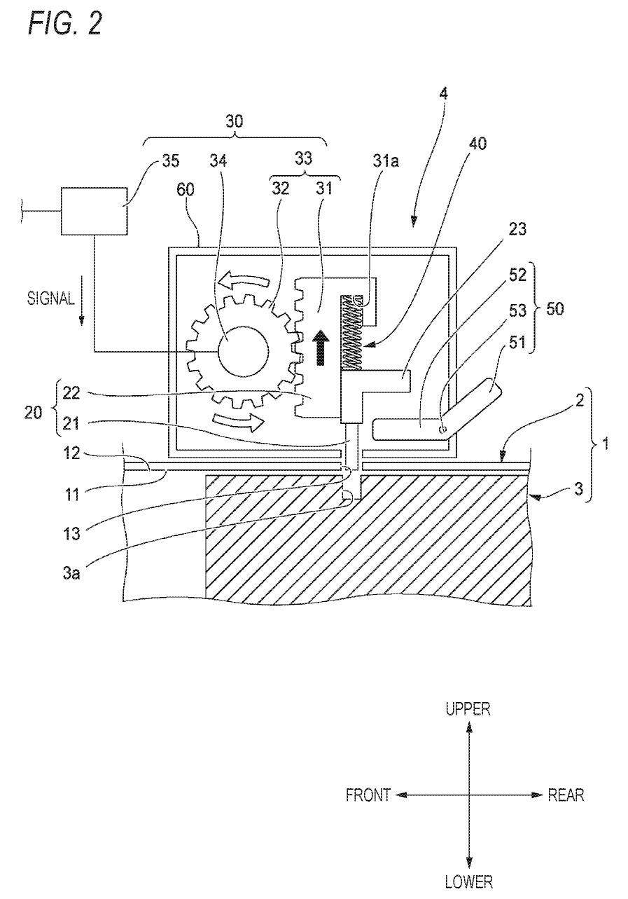

The connector 2 is a connector that is installed in a vehicle such as a plug-in hybrid automatic vehicle or an electric automatic vehicle, and is connected to an electric wire extending from a battery mounted on the vehicle, and is also called a charging inlet. The connector 3 is a connector connected to an electric wire extending from a power supply outside the vehicle and is also called a charging gun. By fitting the connector 3 into the fitting recess 11 of the connector 2, power is supplied to the battery from the outside of the vehicle, and the battery is charged. The actuator portion 4 of the connector 2 selectively switches the position of a pin member 20 to be described later between a protruding position (the position illustrated in FIG. 1) and a retracted position (the position illustrated in FIG. 2) to fulfill a function of switching between engagement and disengagement between the pin member 20 of the connector 2 and the connector 3.

Hereinafter, for convenience of description, "front", "rear", "left", "right", "upper", and "lower" are defined as illustrated in FIG. 1 and the like. A "front-rear direction", a "left-right direction", and an "upper-lower direction" are orthogonal to one another. The front-rear direction coincides with a fitting direction of the connector 2 and the connector 3. The front-rear direction, the left-right direction, and the upper-lower direction do not necessarily coincide with a front-rear direction, a left-right direction, and an upper-lower direction of a vehicle or the like when the connector 2 is mounted on the vehicle or the like.

As illustrated in FIG. 1, in this example, the fitting recess 11 of the connector 2 is a recess that opens rearward and is recessed forward. A through hole 13 penetrating in the upper-lower direction is formed in an upper portion of an annular peripheral wall 12 defining the fitting recess 11. An engagement recess 3a that opens upward and is recessed downward is formed on an outer periphery surface on an upper side of the connector 3 fitted into the fitting recess 11, corresponding to the through hole 13. As illustrated in FIG. 1, in a state in which the connector 3 is fitted into the fitting recess 11 (a fitted state of the connector 2 and the connector 3), the engagement recess 3a of the connector 3 is adjacently disposed immediately below the through hole 13 of the connector 2, and the engagement pin portion 21 of the pin member 20 of the connector 2 (the actuator portion 4) disposed to be insertable into the through hole 13 can be inserted into the engagement recess 3a.

The actuator portion 4 is provided above the peripheral wall 12 of the connector 2 in which the through hole 13 is formed. As illustrated in FIG. 1, the actuator portion 4 includes the pin member 20, a drive portion 30, an elastic portion 40, and an operation lever 50. The actuator portion 4 includes a case 60 that integrally accommodates the pin member 20, the drive portion 30, the elastic portion 40, and the operation lever 50. Hereinafter, the configuration of each portion constituting the actuator portion 4 will be described in order.

The pin member 20 has a shape extending in the upper-lower direction and is supported by the actuator portion 4 so as to be movable in parallel in the upper-lower direction. The pin member 20 integrally includes a rod-shaped metal engagement pin portion 21 extending in the upper-lower direction and a metal or resin plunger portion 22 located above the engagement pin portion 21 and having a shape extending in the upper-lower direction. The engagement pin portion 21 is disposed to be insertable into the through hole 13. The plunger portion 22 is integrally provided with an extending portion 23 extending laterally (rearward) from an upper end portion of the plunger portion 22. The extending portion 23 of the pin member 20 is engageable with an output side lever portion 52 (to be described later) of the operation lever 50, and functions to move the pin member 20 upward by receiving an upward force from the output side lever portion 52 of the operation lever 50.

The drive portion 30 includes a rack-and-pinion mechanism 33 including a metal rack gear 31 and a metal pinion gear 32, an electric actuator 34 that rotationally drives the pinion gear 32, and a processing unit 35 that drives and controls the electric actuator 34. The rack gear 31 is supported by the actuator portion 4 so as to be movable in parallel in the upper-lower direction independently of the pin member 20. The pinion gear 32 is supported by the actuator portion 4 so as to be rotatable about a central axis of the pinion gear 32 in a state of being engaged with the rack gear 31. Therefore, when the pinion gear 32 rotationally moves, the rack gear 31 moves in parallel in the upper-lower direction. The processing unit 35 is a microcomputer and operates the electric actuator 34 based on signals received from various sensors and the like mounted on the vehicle.

Specifically, the elastic portion 40 is a metal coil spring that extends in the upper-lower direction and is elastically deformable in the upper-lower direction. The elastic portion 40 is disposed between the upper end portion of the plunger portion 22 of the pin member 20 and a facing portion 31a that is a part of the rack gear 31 disposed to face the upper end portion of the plunger portion 22 at an interval in the upper-lower direction, an upper end of the elastic portion 40 is fixed to the facing portion 31a of the rack gear 31, and a lower end of the elastic portion 40 is fixed to the upper end portion of the plunger portion 22 of the pin member 20. The elastic portion 40 functions to transmit the operation of the drive portion 30 (specifically, the movement of the rack gear 31 in the upper-lower direction) to the pin member 20.

The operation lever 50 includes an input side lever portion 51 and the output side lever portion 52 that extend in directions intersecting each other, and a support portion 53 that supports the operation lever 50 on the actuator portion 4 such that the operation lever 50 is swingable about a boundary portion between the input side lever portion 51 and the output side lever portion 52. The input side lever portion 51 is exposed to the outside of the case 60 of the actuator portion 4, and is disposed to be operable from the outside of the actuator portion 4 independently of the operation of the drive portion 30. The output side lever portion 52 is disposed to be engageable with the extending portion 23 of the pin member 20. The configuration of each portion constituting the actuator portion 4 has been described above.

Next, the operation of the actuator portion 4 will be described. The electric actuator 34 controls the position of the pinion gear 32 in a rotation direction, that is, the position of the rack gear 31 engaged with the pinion gear 32 in the upper-lower direction to be selectively switched between a first position illustrated in FIG. 1 and a second position (a position above the first position) illustrated in FIG. 2 based on a drive signal from the processing unit 35. The pin member 20 is connected to the rack gear 31 in the upper-lower direction via the elastic portion 40. Therefore, when the rack gear 31 is at the first position, the pin member 20 is at the protruding position where a lower end of the engagement pin portion 21 protrudes downward from the through hole 13 (see FIG. 1), and when the rack gear 31 is at the second position, the pin member 20 is at the retracted position (position above the protruding position) where the lower end of the engagement pin portion 21 does not protrude downward from the through hole 13 (see FIG. 2). Further, when the pin member 20 is at the protruding position, the extending portion 23 of the pin member 20 comes into contact with the output side lever portion 52 of the operation lever 50, thereby regulating the position of the pin member 20 so that the pin member 20 attached to the elastic portion 40 does not move excessively downward. When the rack gear 31 moves from the first position to the second position (or from the second position to the first position), the movement of the rack gear 31 is transmitted to the pin member 20 via the elastic portion 40 with appropriate responsiveness of the elastic portion 40, so that the pin member 20 moves from the protruding position to the retracted position (or from the retracted position to the protruding position).

As illustrated in FIG. 1, in a state in which the connector 3 is fitted into the fitting recess 11 of the connector 2 (a fitted state of the connector 2 and the connector 3), as described above, the engagement recess 3a of the connector 3 is adjacently disposed immediately below the through hole 13 of the connector 2, and the engagement pin portion 21 of the pin member 20 can be inserted into the engagement recess 3a of the connector 3. Therefore, as illustrated in FIG. 1, in a state where the pin member 20 is at the protruding position, the engagement pin portion 21 of the pin member 20 is disposed inside the engagement recess 3a of the connector 3, and the pin member 20 of the connector 2 and the connector 3 are engaged with each other. Therefore, in a state where the pin member 20 is at the protruding position, the rearward movement of the connector 3 with respect to the fitting recess 11 of the connector 2 is regulated by the pin member 20, and thus the connector 3 is prevented from being unintentionally separated from the fitting recess 11. On the other hand, as illustrated in FIG. 2, in a state where the pin member 20 is at the retracted position, the engagement pin portion 21 of the pin member 20 is disposed outside the engagement recess 3a of the connector 3 (above the engagement recess 3a), and the pin member 20 of the connector 2 and the connector 3 are not engaged with each other. Therefore, in a state where the pin member 20 is at the retracted position, the rearward movement of the connector 3 with respect to the fitting recess 11 of the connector 2 is not regulated by the pin member 20, and thus the connector 3 can be separated from the fitting recess 11. Here, the state where the pin member 20 is at the protruding position corresponds to the "engagement position" of the present disclosure, and the state where the pin member 20 is at the retracted position corresponds to the "disengagement position" of the present disclosure.

In this example, the processing unit 35 of the actuator portion 4 controls the electric actuator 34 so as to rotationally drive the pinion gear 32 based on the signals received from various sensors and the like mounted on the vehicle, and selectively switches an upper-lower direction position of the pin member 20, for example, to the protruding position only when it is detected that the battery of the vehicle is being charged, and to the retracted position in other cases (when it is not detected that the battery of the vehicle is being charged).

Specifically, when the battery of the vehicle is charged, first, the connector 3 is inserted and fitted into the fitting recess 11 of the connector 2. At this stage, since the battery has not yet been charged, the pin member 20 is at the retracted position (the rack gear 31 is at the second position). Next, when charging of the battery is started, in response to the processing unit 35 detecting that the battery of the vehicle is being charged, the pinion gear 32 is rotationally driven by the electric actuator 34 to move the rack gear 31 from the second position to the first position. Accordingly, the rack gear 31 moves from the second position to the first position, the pin member 20 connected to the rack gear 31 via the elastic portion 40 moves from the retracted position to the protruding position, and the engagement pin portion 21 of the pin member 20 is disposed inside the engagement recess 3a of the connector 3, so that the pin member 20 of the connector 2 and the connector 3 are engaged with each other (see FIG. 1). Therefore, during charging of the battery, the connector 3 is prevented from being unintentionally separated from the fitting recess 11 of the connector 2.

Next, when the charging of the battery ends, the pinion gear 32 is rotationally driven by the electric actuator 34 so as to move the rack gear 31 from the first position to the second position in response to the processing unit 35 not detecting that the battery of the vehicle is being charged.

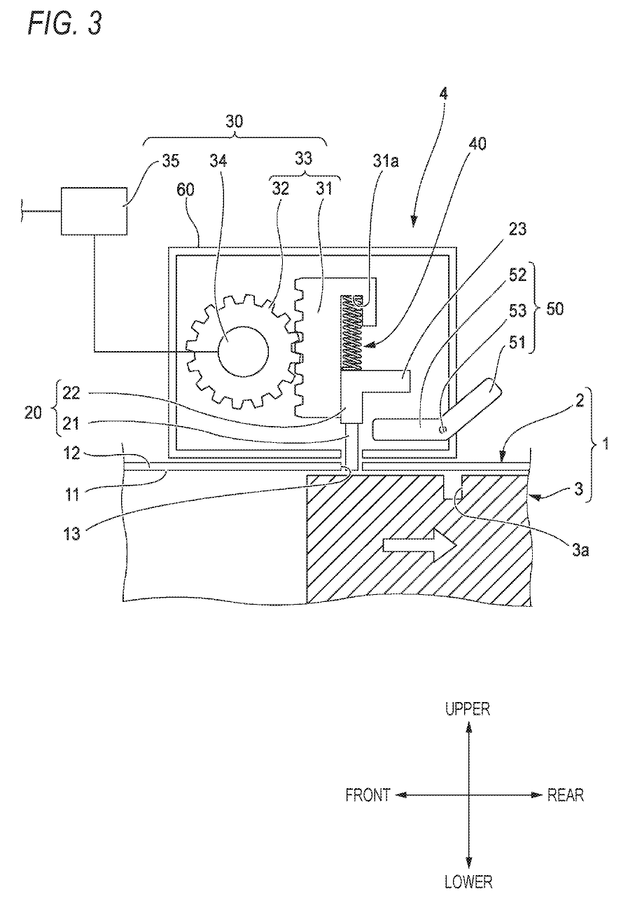

Here, when the actuator portion 4 is normal, the pinion gear 32 is appropriately rotationally moved by the electric actuator 34 as indicated by a white arrow in FIG. 2. Accordingly, as indicated by a black arrow in FIG. 2, the rack gear 31 moves from the first position to the second position, the pin member 20 connected to the rack gear 31 via the elastic portion 40 moves from the protruding position to the retracted position, and the engagement pin portion 21 of the pin member 20 is disposed outside the engagement recess 3a of the connector 3, so that the engagement between the pin member 20 of the connector 2 and the connector 3 is released (see FIG. 2). Therefore, when the charging of the battery is completed, the connector 3 can be separated from the fitting recess 11. Therefore, as indicated by a white arrow in FIG. 3, the connector 3 can be separated from the connector 2 by pulling the connector 3 rearward from the fitting recess 11.

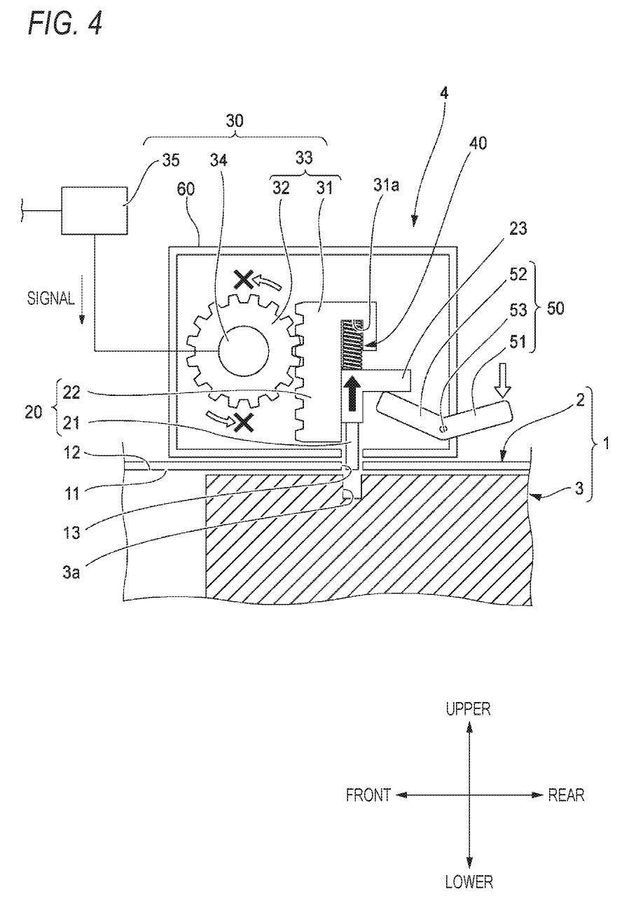

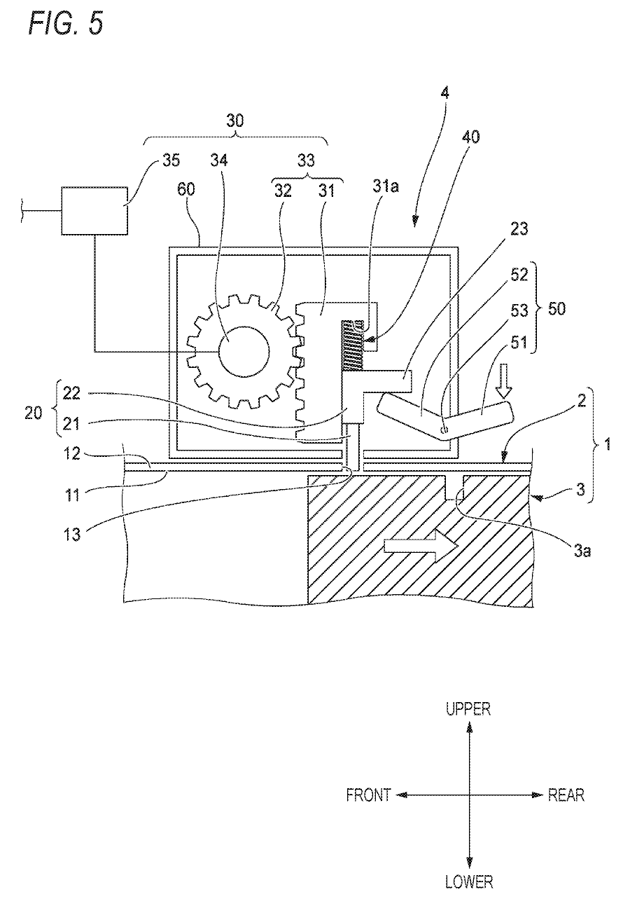

On the other hand, as illustrated in FIG. 4, when there is some abnormality in the actuator portion 4, even if an attempt is made to rotationally drive the pinion gear 32 by the electric actuator 34 so as to move the rack gear 31 from the first position to the second position, the rack gear 31 is maintained at the first position without moving from the first position, so that the pin member 20 is maintained at the protruding position. In FIG. 4, as an example, it is assumed that the pin member 20 is maintained at the protruding position by the rack gear 31 not moving from the first position due to the occurrence of an abnormality in which the pinion gear 32 cannot rotationally move. In this case, the engagement between the pin member 20 of the connector 2 and the connector 3 cannot be released, and the connector 3 cannot be separated from the connector 2. In such an emergency, as indicated by a white arrow in FIG. 4, a user pushes downward the input side lever portion 51 of the operation lever 50. Accordingly, the operation lever 50 swings about the support portion 53, and the output side lever portion 52 pushes up the extending portion 23 of the pin member 20 engaged with the output side lever portion 52 while resisting an appropriate elastic biasing force of the elastic portion 40. Accordingly, as indicated by a black arrow in FIG. 4, the pin member 20 moves from the protruding position to the retracted position while elastically deforming the elastic portion 40 in a direction in which the elastic portion 40 is compressed in the upper-lower direction, and the engagement between the pin member 20 of the connector 2 and the connector 3 is released (see FIG. 4). This series of operations using the operation lever 50 is also called a release operation. As indicated by a white arrow in FIG. 5, the connector 3 can be separated from the connector 2 by pulling the connector 3 rearward from the fitting recess 11 while maintaining a state in which the input side lever portion 51 of the operation lever 50 is pressed downward by the release operation (that is, a state in which the pin member 20 is at the retracted position).

### Action and Effects

As described above, according to the actuator portion 4 and the connector unit 1 of the present embodiment, the operation of the drive portion 30 provided in a first connector (the connector 2, the charging inlet) is transmitted to an engagement portion (the pin member 20) via the elastic portion 40, so that the engagement portion 20 is disposed at the engagement position (the protruding position) or the disengagement position (the retracted position). Even if a malfunction occurs in the operation of the drive portion 30, the engagement between the second connector (the connector 3, the charging gun), which is the engagement target, and the engagement portion (the pin member 20) can be released by performing the release operation of moving the engagement portion 20 at the engagement position toward the disengagement position while elastically deforming the elastic portion 40 using an operation portion (the operation lever 50) independent of the operation of the drive portion 30. Therefore, the connector unit 1 according to the present embodiment can appropriately switch between engagement and disengagement between the engagement portion 20 of the first connector 2 and the second connector 3.

Further, according to the actuator portion 4 and the connector unit 1 of the present embodiment, by using the coil spring as the elastic portion 40, when the drive portion 30 is operating normally, the operation of the drive portion 30 is transmitted to the engagement portion 20 via the coil spring with appropriate responsiveness, and when a malfunction occurs in the drive portion 30, the elastic portion 40 can be elastically deformed with an appropriate operation force by the operation portion 50.

Further, according to the actuator portion 4 and the connector unit 1 of the present embodiment, the operation lever 50 has the function of regulating the position of the pin member 20 so that the pin member 20 can be appropriately disposed at the engagement position in addition to the function of executing the release operation described above. Accordingly, the actuator portion 4 and the connector unit 1 can be reduced in size as compared with a case where these functions are performed by separate members.

### Other Embodiments

The present disclosure is not limited to the embodiment described above, and various modifications can be adopted within the scope of the present disclosure. For example, the present disclosure is not limited to the embodiment described above, and modifications, improvements, and the like can be appropriately made. In addition, materials, shapes, sizes, numbers, arrangement positions, and the like of components in the embodiment described above are freely selected and are not limited as long as the present disclosure can be implemented.

In the above embodiment, the operation lever 50 of the actuator portion 4 is provided in the case 60 integrally with other members (that is, the pin member 20, the drive portion 30, and the elastic portion 40). On the other hand, the operation lever 50 may be attached to the case 60 as a component separate from the other members as necessary.

Here, the features of the actuator portion 4 and the connector unit 1 according to the embodiment of the present disclosure described above are briefly summarized and listed in the following [1] to [4].

[1] An engagement mechanism (4) capable of switching between engagement and disengagement with an engagement target (3), the engagement mechanism (4) including:

an engagement portion (20) configured to be disposed at an engagement position where the engagement portion (20) is engaged with the engagement target (3) and a disengagement position where the engagement portion (20) is not engaged with the engagement target (3);

a drive portion (30) configured to operate to dispose the engagement portion (20) at the engagement position or the disengagement position;

an elastic portion (40) provided between the drive portion (30) and the engagement portion (20), configured to transmit the operation of the drive portion (30) to the engagement portion (20), and elastically deformable; and

an operation portion (50) configured to execute a release operation of moving the engagement portion (20) at the engagement position toward the disengagement position while elastically deforming the elastic portion (40), independently of the operation of the drive portion (30).

According to the engagement mechanism having the configuration of the above [1], the operation of the drive portion (for example, a gear structure such as a rack and a pinion, and a power source such as a motor) is transmitted to the engagement portion (for example, a lock pin) via the elastic portion (for example, a coil spring), so that the engagement portion is disposed at the engagement position or the disengagement position. Even if a malfunction occurs in the operation of the drive portion, the engagement between the engagement target and the engagement portion can be released by performing the release operation of moving the engagement portion at the engagement position toward the disengagement position while elastically deforming the elastic portion using the operation portion (for example, an emergency lever) independent of the operation of the drive portion. Therefore, the engagement mechanism of the present configuration can appropriately switch between the engagement and disengagement with the engagement target.

[2] In the engagement mechanism (4) according to the above [1],

the elastic portion (40) is a coil spring.

According to the engagement mechanism having the configuration of the above [2], by using the coil spring as the elastic portion, when the drive portion is operating normally, the operation of the drive portion is transmitted to the engagement portion via the coil spring with appropriate responsiveness, and when a malfunction occurs in the drive portion, the elastic portion can be elastically deformed with an appropriate operation force by the operation portion.

[3] In the engagement mechanism (4) according to the above [2],

when not performing the release operation, the operation portion (50) comes into contact with the engagement portion (20) disposed at the engagement position to regulate a position of the engagement portion (20).

According to the engagement mechanism having the configuration of the above [3], the operation portion has a function of regulating the position of the engagement portion so that the engagement portion can be appropriately disposed at the engagement position in addition to the function of executing the release operation described above. Accordingly, the engagement mechanism can be reduced in size as compared with a case where these functions are performed by separate members.

[4] A connector unit (1) including:

a first connector (2) including the engagement mechanism (4) according to any one of the above [1] to [3]; and

a second connector (3) as the engagement target.

According to the connector unit having the configuration of the above [4], the operation of the drive portion provided in the first connector (for example, the charging inlet) is transmitted to the engagement portion via the elastic portion, so that the engagement portion is disposed at the engagement position or the disengagement position. Even if a malfunction occurs in the operation of the drive portion, the engagement between the second connector (for example, the charging gun), which is the engagement target, and the engagement portion can be released by performing the release operation of moving the engagement portion at the engagement position toward the disengagement position while elastically deforming the elastic portion using the operation portion (for example, an emergency lever) independent of the operation of the drive portion. Therefore, the connector unit of this configuration can appropriately switch between engagement and disengagement between the engagement portion of the first connector and the second connector.

What is claimed is:

1. An engagement mechanism capable of switching between engagement and disengagement with an engagement target, the engagement mechanism comprising:
an engagement portion that is disposed at an engagement position where the engagement portion is engaged with the engagement target and a disengagement position where the engagement portion is not engaged with the engagement target;
a drive portion that operates to dispose the engagement portion at the engagement position or the disengagement position;
an elastic portion that is provided between the drive portion and the engagement portion, transmits the operation of the drive portion to the engagement portion, and is elastically deformable; and
an operation portion that executes a release operation of moving the engagement portion at the engagement position toward the disengagement position while elastically deforming the elastic portion, independently of the operation of the drive portion.

2. The engagement mechanism according to claim 1, wherein
the elastic portion is a coil spring.

3. The engagement mechanism according to claim 2, wherein
when not performing the release operation, the operation portion comes into contact with the engagement portion disposed at the engagement position to regulate a position of the engagement portion.

4. A connector unit comprising:
a first connector including the engagement mechanism according to claim 1; and
a second connector as the engagement target.
